(19) United States
(12) Patent Application Publication
(10) Pub. No.: US 2025/0284504 A1
(43) Pub. Date: Sep. 11, 2025

(54) INTERFACE MODULE, INFORMATION COMMUNICATION DEVICE, AND ACTIVATION METHOD

(71) Applicant: Hitachi Vantara, Ltd., Kanagawa-ken (JP)

(72) Inventor: Takashi NOGUCHI, Tokyo (JP)

(21) Appl. No.: 18/882,536

(22) Filed: Sep. 11, 2024

(30) Foreign Application Priority Data
Mar. 6, 2024 (JP) 2024-034188

(51) Int. Cl. G06F 9/445

(52) U.S. Cl. CPC G06F 9/44505

(57) ABSTRACT

An interface module includes: a non-volatile storage area that stores one or more versions of firmware and a mode file; and a processor that executes a program code included in the firmware, in which each version of the firmware includes: a plurality of protocol-based program codes; and an activation unit that activates at least one of the plurality of protocol-based program codes based on description of the mode file.

### CROSS REFERENCE TO RELATED APPLICATIONS

This application claims priority to Japanese Patent Application No. 2024-034188, filed Mar. 6, 2024, the contents of which are incorporated herein by reference in its entirety for all purposes.

### BACKGROUND OF THE INVENTION

### 1. Technical Field

The present invention relates to an interface module, an information communication device, and an activation method.

### 2. Description of the Related Art

Since network protocols used by storages are being newly developed day by day, the storages need to support various network protocols. Conventionally, since an available network protocol is fixed for each channel board (hereafter referred to as “CHB”), it has been necessary to replace the CHB or reconnect a network cable in order to change the network protocol used by the storage. In recent years, a CHB capable of changing a network protocol has also been developed. By using this CHB, there is no need to replace the CHB or reconnect the network cable. For example, techniques disclosed in JP 2015-32304 A and JP 2007-513436 A have been known regarding a storage supporting a plurality of protocols.

### SUMMARY OF THE INVENTION

Even though any of JP 2015-32304 A and JP 2007-513436 A is applied, it is not possible to designate a network protocol to be set in advance at the time of activating the CHB. Therefore, when the desired network protocol is not set at the time of activating the CHB, it is necessary to designate an NW protocol and re-activate the CHB, and there is a problem that the time until the storage becomes available becomes long.

An interface module according to a first aspect of the present invention is an interface module including: a non-volatile storage area that stores one or more versions of firmware and a mode file; and a processor that executes a program code included in the firmware, in which each version of the firmware includes: a plurality of protocol-based program codes; and an activation unit that activates at least one of the plurality of protocol-based program codes based on description of the mode file.

An information communication device including: a first interface module that is the aforementioned interface module; and a storage controller that receives at least one of a read command and a write command via the first interface module.

An activation method according to a third aspect of the present invention is an activation method executed by an interface module including: a non-volatile storage area that stores one or more versions of firmware and a mode file; and a processor that executes a program code included in the firmware, each version of the firmware including: a plurality of protocol-based program codes; and an activation unit that activates at least one of the plurality of protocol-based program codes based on description of the mode file, the activation method including: the processor operating the activation unit of any one version of the firmware to activate at least one of the plurality of protocol-based program codes based on the description of the mode file.

According to the present invention, since it is not necessary to switch a protocol by firmware exchange while supporting a plurality of network protocols, it is possible to minimize downtime. In addition, since it is not necessary to prepare separate firmware for each protocol, not only hardware but also software can be unified.

### BRIEF DESCRIPTION OF THE DRAWINGS

FIG. 1 is an overall configuration diagram of a storage system including a smart NIC;

FIG. 2 is a diagram illustrating examples of a CPU setting table, a protocol setting table, and a session management table;

FIG. 3 is a configuration diagram of the smart NIC;

FIG. 4 is a detailed configuration diagram of an embedded memory;

FIG. 5 is a diagram illustrating examples of a smart NIC operation protocol mode table and a CPU setting table;

FIG. 6 is a diagram illustrating examples of a connection management table, a task management table, and a CPU management table;

FIG. 7 is a diagram illustrating an outline of processing executed by the smart NIC;

FIG. 8 is a diagram illustrating an example of allocation of CPU cores in the smart NIC;

FIG. 9 is a schematic diagram illustrating processing for each core of the smart NIC;

FIG. 10 is a diagram for explaining a queue handling dedicated mode and a queue handling dual mode;

FIG. 11 is a flowchart illustrating processing at the time of hardware initial setting of the smart NIC;

FIG. 12 is a flowchart illustrating processing at the time of normal activation of the smart NIC;

FIG. 13 is a flowchart illustrating processing of the smart NIC when an IF mode of the smart NIC is switched by a user;

FIG. 14 is a time chart illustrating processing of the storage system when the IF mode of the smart NIC is switched by the user;

FIG. 15 is a time chart illustrating processing of the storage system when the IF mode of the smart NIC is switched by the user;

FIG. 16 is a time chart illustrating processing at the time of hardware initial setting of the smart NIC;

FIG. 17 is a time chart illustrating processing at the time of hardware initial setting of the smart NIC; and

FIG. 18 is an overall configuration diagram of a storage system according to a second embodiment.

### DETAILED DESCRIPTION

### FIRST EMBODIMENT

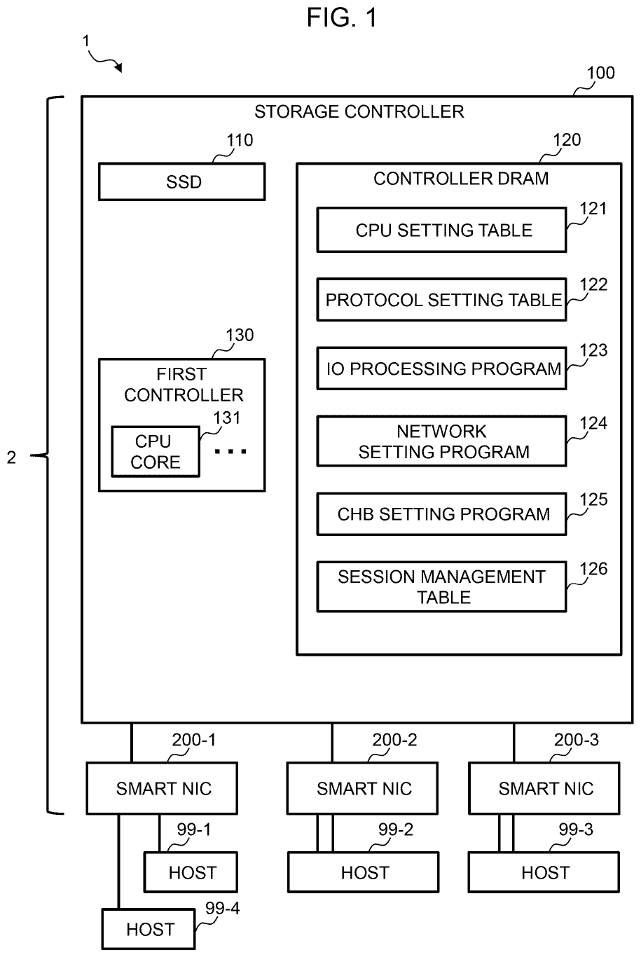

Hereinafter, a smart NIC that is an interface module according to a first embodiment will be described with reference to FIGS. 1 to 16. In the present embodiment, a network interface card is also referred to as “NIC”, an interface is also referred to as “IF”, a network is also referred to as “NW”, and a channel board is also referred to as “CHB”.

FIG. 1 is an overall configuration diagram of a storage system 1 including a smart NIC 200. The storage system 1 includes a storage controller 100, at least one smart NIC 200, and at least one host 99. In FIG. 1, branch numbers are assigned to identify the plurality of smart NICs 200 and the plurality of hosts. The smart NICs 200 have a common configuration to the extent described below.

Although the storage controller 100 is connected to three smart NICs 200 in FIG. 1, the number of smart NICs 200 connected to the storage controller 100 may be one or more. The storage controller 100 identifies each smart NIC 200 by a channel board ID. The channel board ID is an identifier of a channel board, that is, a smart NIC 200, and is expressed by a combination of “C” and a number in the present embodiment. That is, channel board IDs “C1”, “C2”, and “C3” are set to the three illustrated smart NICs 200.

The smart NIC 200 is connected to the storage controller 100 according to a prescribed communication standard, for example, PICe. Communication is performed between the smart NIC 200 and the host 99 according to a communication protocol that is publicly known or that will be developed in the future. The communication protocol is iSCSI, Infini Band, NVMe over TCP, RoCE V2, or the like. The communication protocol used for communication between the smart NIC 200 and the host 99 can be changed. This will be described in detail below.

The storage controller 100 includes an SSD 110, a controller DRAM 120, and a first controller 130. The SSD 110 is a non-volatile memory using a semiconductor, that is, a solid state drive. Note that the SSD21 is merely described as an example of a non-volatile storage device, and another non-volatile storage device such as a hard disk drive may be used. The controller DRAM 120 is a volatile memory using a semiconductor, that is, a dynamic random access memory.

The controller DRAM 120 stores a CPU setting table 121, a protocol setting table 122, an IO processing program 123, a network setting program 124, a channel board setting program 125, and a session management table 126. However, data and programs stored in the controller DRAM 120 are read from a ROM (not illustrated) at the time of activation. The first controller 130 includes one or more CPUs 131. The CPU131 develops a program code stored in a ROM (not illustrated) in the controller DRAM 120 and executes the program code.

The IO processing program 123 writes data to the SSD 110 and reads data from the SSD 110 based on an operation command received from the host 99 via the smart NIC 200. The storage controller 100 receives a protocol data unit (PDU) according to a predetermined communication protocol from the smart NIC 200, and operates based on an operation command included in the PDU. The predetermined communication protocol is a communication protocol that is publicly known or that will be developed in the future, and is iSCSI, Infini Band, NVMe over TCP, or the like. The PDU is also referred to as a network packet, a network frame, communication data, or the like.

The network setting program 124 generates a session between the host 99 and the storage controller 100 and updates the session management table 126. The CHB setting program 125 provides a setting screen to an operator, and creates or updates the CPU setting table 121 and the protocol setting table 122 based on an operator's input. Hereinafter, the storage controller 100 and at least one smart NIC 200 are collectively referred to as an information communication device 2.

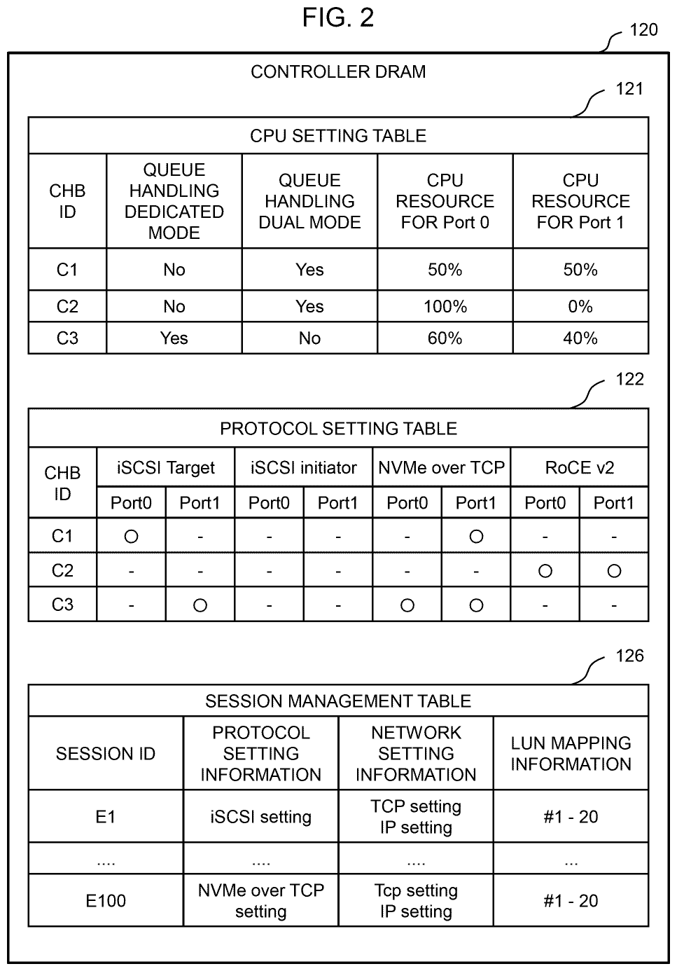

FIG. 2 is a diagram illustrating examples of the CPU setting table 121, the protocol setting table 122, and the session management table 126 stored in the controller DRAM 120 of the storage controller 100.

The CPU setting table 121 stores settings for a CPU core 132 mounted on each smart NIC 200. Specifically, the CPU setting table 121 includes a channel board ID, a queue handling dedicated mode, a queue handling dual mode, a CPU resource for port 0, and a CPU resource for port 1.

The queue handling dedicated mode and the queue handling dual mode are settings for operating the CPU core 132 in one of the queue handling dedicated mode and the queue handling dual mode. The queue handling dedicated mode and the queue handling dual mode have a front and back relationship in which one is set to “Yes” and the other is set to “No”. The CPU resource for port 0 and the CPU resource for port 1 are settings for allocating the CPU core 132. The sum of the CPU resource for port 0 and the CPU resource for port 1 is less than or equal to 100%.

In the protocol setting table 122, a communication protocol for each port is set for each smart NIC 200. Specifically, for each channel board ID, it is described whether each protocol and each port can be applied. In the example illustrated in FIG. 2, it is described, for a smart NIC 200 of which the channel board ID is “C1”, that port 0 supports only “iSCSI Target”, and port 1 supports only “NVMe over TCP”. Each port is not limited to supporting one protocol, and for example, for a smart NIC 200 of which the channel board ID is “C3”, port 1 supports both “iSCSI Target” and “NVMe over TCP”.

Data for each session is stored in the session management table 126. Specifically, a session ID, protocol setting information, network setting information, and LUN mapping information are included. The session ID is a session identifier, and is expressed by a combination of “E” and a number in the present embodiment. The protocol setting information is setting data related to a communication protocol to be used. Although “iSCSI setting” is described in FIG. 2 for simplification of description, specific setting data is actually stored. The network setting information is setting data related to a network. Although “TCP setting, IP setting” is described in FIG. 2 for simplification of description, specific setting data is actually stored. The LUN mapping information is an identifier of a logical unit number to be used.

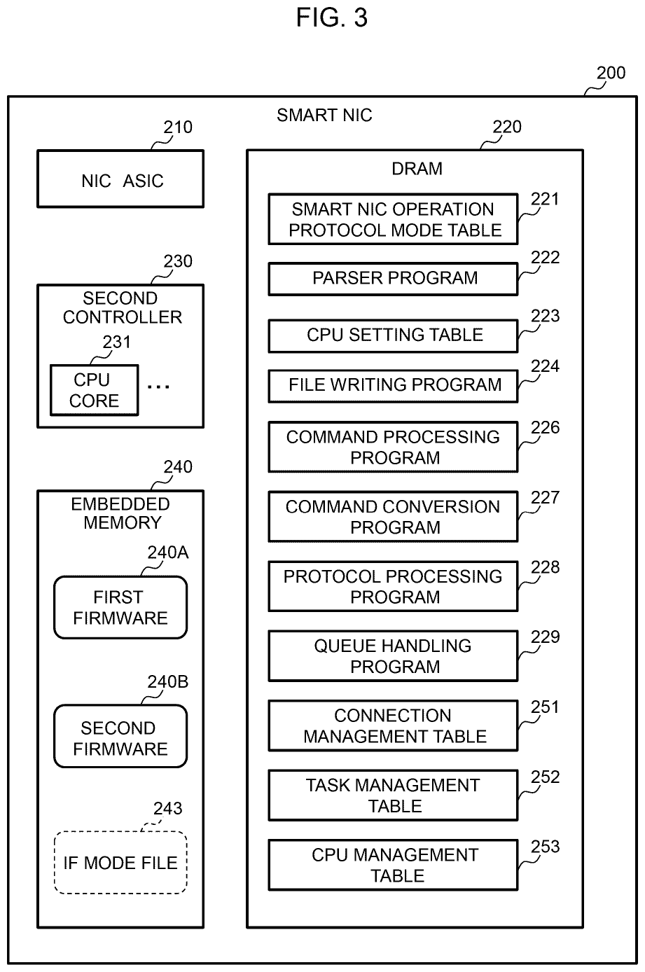

FIG. 3 is a configuration diagram of the smart NIC 200. The smart NIC 200 includes an NIC ASIC 210, a DRAM 220, a second controller 230, and an embedded memory 240. The smart NIC 200 includes one or more communication ports, and there is no upper limit on the number of communication ports. However, in the present embodiment, a configuration in a case where the smart NIC 200 has two communication ports, port 0 and port 1, will be specifically described. The smart NIC 200 supports a plurality of network protocols, and can set an IF mode for each communication port to simultaneously support at least the same number of network protocols as the ports. For example, “iSCSI Target” can be set to port 0 and “NVMe over TCP” can be set to port 1, or “RoCE V2” can be set to both ports.

The NIC ASIC 210 is an integrated circuit for a specific application that executes processing necessary for operating the NIC, that is, an application specific integrated circuit. The NIC ASIC 210 performs processing independent of a network protocol or processing common to a plurality of network protocols. The DRAM 220 is a volatile memory using a semiconductor, that is, a dynamic random access memory.

The DRAM 220 stores a smart NIC operation protocol mode table 221, a parser program 222, a CPU setting table 223, a file writing program 224, a command processing program 226, a command conversion program 227, a protocol processing program 228, a queue handling program 229, a connection management table 251, a task management table 252, and a CPU management table 253. The protocol processing program 228 is a general term, and actually, a program supporting a communication protocol processed by each port of the smart NIC 200 is stored in the DRAM 220.

The protocol processing program 228 is at least one of an iST program 2281, an NVMe program 2282, an iSI program 2283, and an Ro program 2284. The iST program 2281 is a program that processes “iSCSI Target”, which is a communication protocol. The NVMe program 2282 is a program that processes “NVMe over TCP”, which is a communication protocol. The iSI program 2283 is a program that processes an “iSCSI initiator”, which is a communication protocol. The Ro program 2284 is a program that processes “RoCE V2”, which is a communication protocol.

For example, in a case where “iSCSI Target” is set to port 0 and “NVMe over TCP” is set to port 1, the iST program 2281 and the NVMe program 2282 are activated as the protocol processing program 228. In addition, in a case where “RoCE V2” is set to both ports, one or two Ro programs 2284 are activated as the protocol processing program 228.

The second controller 230 includes one or more CPU cores 231. Each CPU core 231 is all or some of a plurality of physical CPUs having one or a plurality of arithmetic cores. Although a specific example in which the second controller 230 includes eight CPU cores 231 will be described in the present embodiment, the second controller 230 may include at least one CPU core 231. The CPU core 231 develops a program code stored in the embedded memory 240 into the DRAM 220 and executes the program code. In the present specification, a program stored in the embedded memory 240 before being executed is referred to as a “program code”, and a program code developed in the DRAM 220 is referred to as a “program”. For example, two copies of one program code may be created, and two programs for executing the same processing may be arranged in the DRAM 220.

Referring to the IF mode file 243 and the smart NIC operation protocol mode table 221, the parser program 222 activates at least one of a plurality of protocol-based program codes, for example, the iST program 2281. In a case where the IF mode file 243 does not exist, a specific protocol-based program code is activated based on the description of the smart NIC operation protocol mode table 221.

The command processing program 226 is a program that performs processing that can be performed inside the smart NIC 200. The command processing program 226 performs, for example, processing of initiating or terminating connection. For example, in a case where a command included in the PDU received from the host 99 is reading data stored in the SSD 110, the smart NIC 200 cannot process the command. Therefore, the PDU is converted into a storage interface command (hereinafter also referred to as a “storage I/F command”) and transmitted to the storage controller 100. However, in a case where the command can be processed by the smart NIC 200, the command is processed by the command processing program 226, not transmitted to the storage controller 100.

The command conversion program 227 converts the command included in the PDU. Specifically, the command conversion program 227 rewrites the command included in the PDU received from the host 99 into a general-purpose storage interface command that can be processed by the storage controller 100. In addition, the command conversion program 227 rewrites a command included in the storage interface command received from the storage controller 100 to a command of another communication protocol that can be processed by the host 99 to which a PDU is transmitted. Furthermore, the command conversion program 227 also adds and deletes a task ID and a connection ID to and from the PDU. The queue handling program 229 performs data transfer between a virtual queue and a real queue to be described below. The queue handling program 229 will be described in detail below.

The embedded memory 240 is a non-volatile storage device embedded in the smart NIC 200. The embedded memory 240 stores first firmware 240A, second firmware 240B, and an IF mode file 243. However, as will be described below, the IF mode file 243 is not stored in the embedded memory 240 in a shipped state of the smart NIC 200.

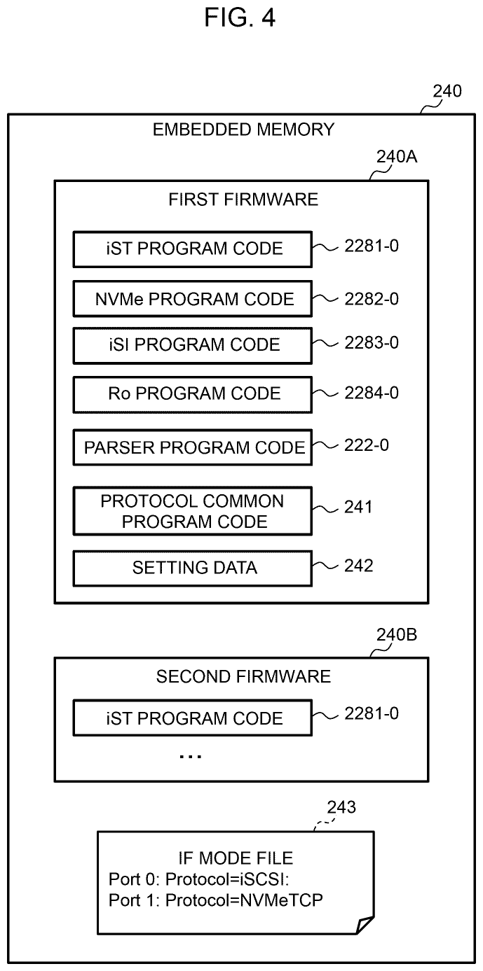

FIG. 4 is a detailed configuration diagram of the embedded memory 240. The embedded memory 240 includes a plurality of versions of firmware for a firmware update, and only one version of firmware is used at a time. The first firmware 240A and the second firmware 240B have substantially the same configuration, but differ in, for example, versions of program codes to be stored. The IF mode file 243 is a text file as illustrated in the lower part of FIG. 4, in which a protocol for each port is described. The configuration of the first firmware 240A will be described below.

The first firmware 240A includes an iST program code 2281-0, an NVMe program code 2282-0, an iSI program code 2283-0, an Ro program code 2284-0, a parser program code 222-0, a protocol common program code 241, and setting data 242.

Each of the iST program code 2281-0, the NVMe program code 2282-0, the iSI program code 2283-0, and the Ro program code 2284-0 is developed in the DRAM 220 to operate as the iST program 2281, the NVMe program 2282, the iSI program 2283, and the Ro program 2284. The parser program code 222-0 is developed in the DRAM 220 to operate as the parser program 222.

The protocol common program code 241 is developed in the DRAM 220 to operate as the command processing program 226, the command conversion program 227, the queue handling program 229, and the file writing program 224. The setting data 242 is developed in the DRAM 220 at the time of activation to become a smart NIC operation protocol mode table 221 and a CPU setting table 223. Note that the connection management table 251, the task management table 252, and the CPU management table 253 are created after activation.

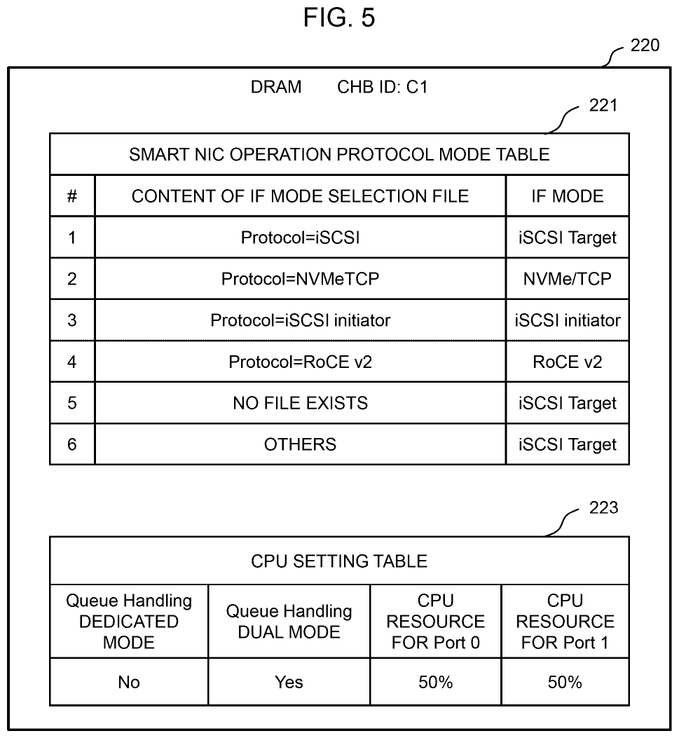

FIG. 5 is a diagram illustrating examples of the smart NIC operation protocol mode table 221 and the CPU setting table 223 stored in the DRAM 220 of the smart NIC 200 of which the channel board ID is “C1”. The smart NIC operation protocol mode table 221 stores correspondence between a content of the IF mode file 243 and an IF mode to be set in the smart NIC 200. As shown in the first to fourth entries, in principle, the network protocols described after “Protocol=” in the IF mode file 243 are set. In a case where the IF mode file 243 does not exist or in a case where other contents are described in the IF mode file 243, “iSCSI” is set as shown in the fifth and sixth entries. However, the protocol used in a case where the IF mode file 243 does not exist or in a case where other contents are described in the IF mode file 243 is not limited to “iSCSI”, and the operator can set any protocol in the smart NIC operation protocol mode table 221.

The CPU setting table 223 stores settings for the second controller 230. Since the storage controller 100 sends an operation command when the smart NIC 200 is initialized based on a CPU setting list 232, the values for the corresponding channel board ID in the CPU setting list 232 are identically described in the CPU setting table 223 of the smart NIC 200. Specifically, the values for the channel board ID “C1” in the CPU setting list 232 shown in FIG. 2 are identically described in the CPU setting table 223 of FIG. 4.

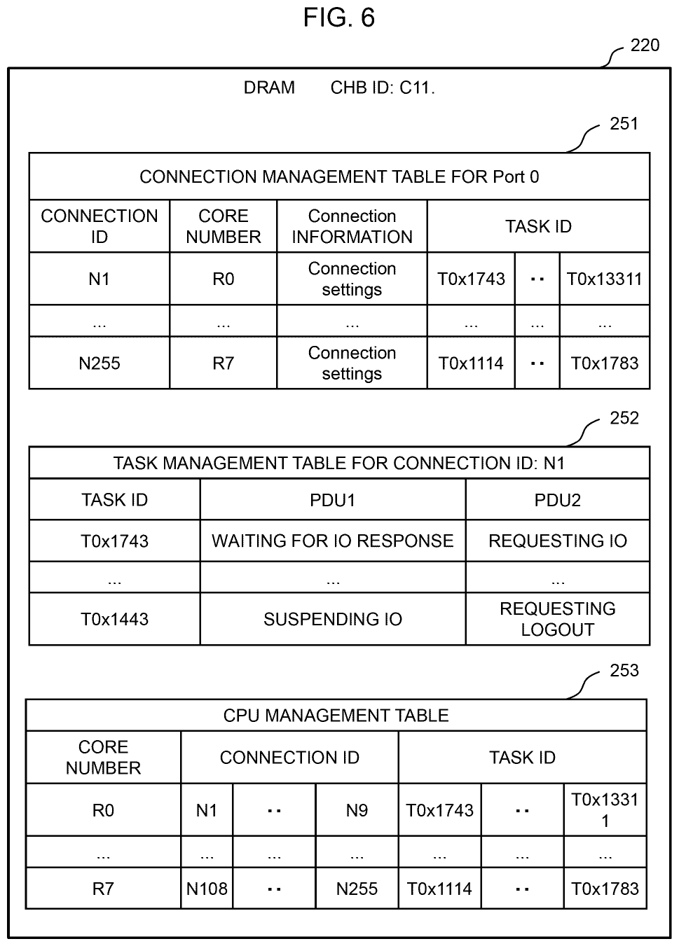

FIG. 6 is a diagram illustrating examples of the connection management table 251, the task management table 252, and the CPU management table 253 stored in the DRAM 220 of the smart NIC 200 of which the channel board ID is “C1”. Connection data for each port is stored in the connection management table 251. An example of the connection management table 251 for port 0 is illustrated in FIG. 6. That is, although not illustrated in FIG. 6, there is also a connection management table 251 in which connections generated using port 1 are described.

Specifically, a connection ID, a core number, connection information, and a task ID are stored in the connection management table 251. The connection ID is an identifier for identifying a connection, and is expressed by a combination of “N” and a number in the present embodiment. The task ID is generated each time an IO is received from the host 99. Since it is common to receive a plurality of PDUs in one connection, the connection ID and the task ID have a one-to-multiple relationship.

The core number is an identifier of a core constituting the second controller 230, and is expressed by a combination of “R” and a number in the present embodiment. The connection information is various data related to a connection. Although “Connection setting” is described in FIG. 6 for simplification of description, specific connection data is actually stored. The task ID is a list of identifiers of tasks associated with the corresponding connection, and is expressed by a combination of “T” and a number in the present embodiment. In FIG. 6, the task ID is described in hexadecimal, but may be described in decimal or the like.

The task management table 252 stores a state for each task. Specifically, PDU1 and PDU2 are stored for each task ID. The CPU management table 253 stores an identifier of a connection and an identifier of a task to be processed for each core of the second controller 230. Note that the relationship between the core number and the connection ID and the relationship between the connection ID and the task ID are described in the connection management table 251. Therefore, the CPU management table 253 can be created based on all the connection management tables 251 included in one smart NIC 200.

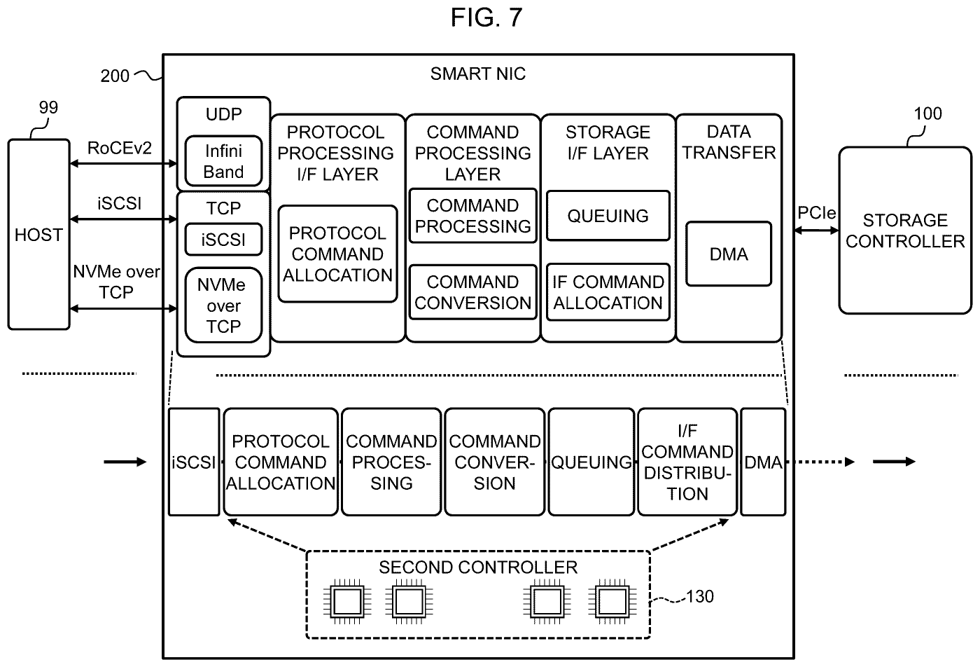

FIG. 7 is a diagram illustrating an outline of processing executed by the smart NIC 200. The smart NIC 200 relays bidirectional communication between the host 99 and the storage controller 100. However, FIG. 7 illustrates a state in which communication from the host 99 to the storage controller 100 is relayed. For communication between the host 99 and the smart NIC 200, various communication protocols such as RoCEv2, iSCSI, and NVMe over TCP are used. For communication between the smart NIC 200 and the storage controller 100, PCIe is used. The smart NIC 200 supports various communication protocols with the host 9 by software processing of the second controller 230.

Upon receiving communication from the host 99, the smart NIC 200 first performs protocol analysis, for example, PDU header analysis. Next, the smart NIC 200 allocates a command. Specifically, it is determined whether it is required to send a command to the storage controller 100. When the smart NIC 200 can process the command by itself, the smart NIC 200 transmits a processing result to the host 9. When it is required to send a command to the storage controller 100, the smart NIC 200 continues the processing. Next, the smart NIC 200 converts the PDU into a storage interface command. Specifically, the received PDU header is rewritten so that the storage controller 100 can interpret the PDU header, and the PDU payload is also processed if necessary. Next, the smart NIC 200 stores a storage interface command in a queue for transmission to the storage controller 100. The queue processing will be described below.

Next, the smart NIC 200 allocates an interface command. Finally, the smart NIC 200 transfers the storage interface command to the controller DRAM 120 of the storage controller 100 by direct memory access (DMA). Note that, in a case where communication from the storage controller 100 to the host 99 is relayed, the flow is opposite to that in FIG. 7.

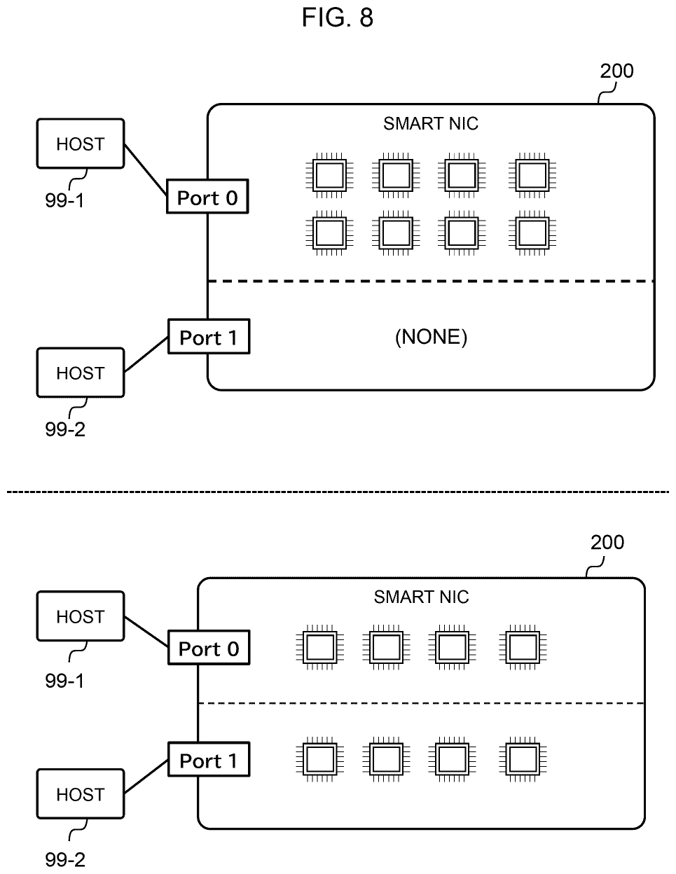

FIG. 8 is a diagram illustrating an example of allocation of the CPU cores 231 in the second controller 230. The allocation of the CPU cores 231 in the second controller 230 is determined based on the description of the CPU setting table 223 when the smart NIC 200 is initialized, for example, when the power is turned on. However, when the smart NIC 200 is initialized, the CPU setting of the corresponding smart NIC 200 may be copied from the CPU setting list 232 of the storage controller 100 to the CPU setting table 223.

In the example illustrated in the upper part of FIG. 8, all the eight cores included in the smart NIC 200 are allocated to port 0. In this case, commands received from the host 99-1 connected to port 0 are processed, but commands received from the host 99-2 connected to port 1 are not processed. In the example illustrated in the lower part of FIG. 8, eight cores included in the smart NIC 200 are equally allocated to port 0 and port 1. In this case, commands received from the host 99-1 and commands received from the host 99-2 are processed in the same ratio. This configuration corresponds to the CPU setting table 223 illustrated in FIG. 5.

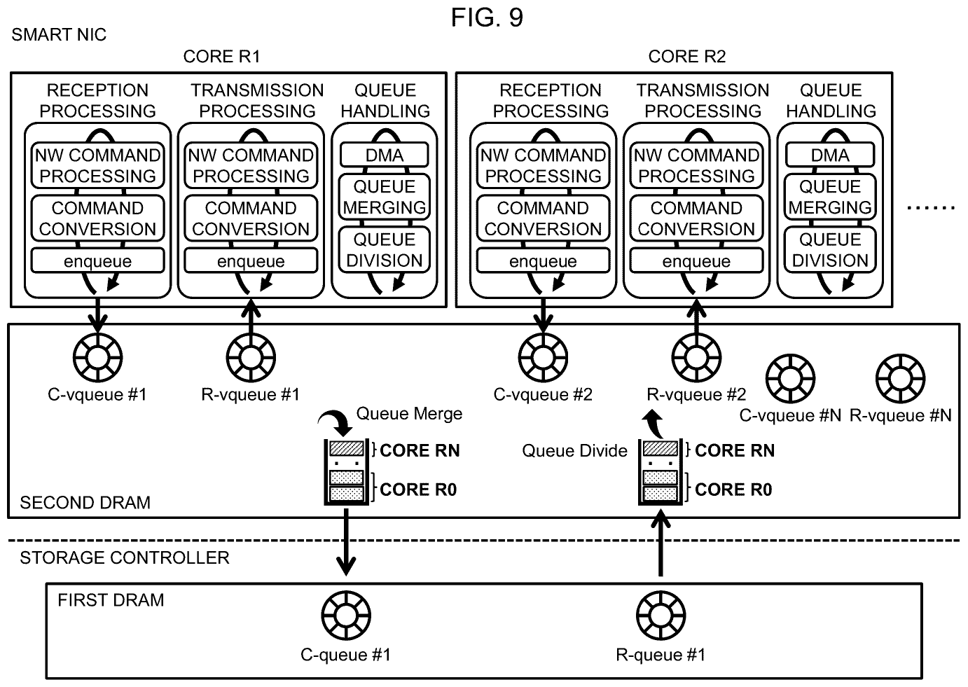

FIG. 9 is a schematic diagram illustrating processing for each core of the smart NIC 200. However, FIG. 9 illustrates an operation in the queue handling dual mode. The storage controller 100 has one command reception queue (C-queue) and one response reply queue (R-queue). The command reception queue is a queue that stores a command from the host 99. The response reply queue is a queue that stores a reply command to the host 99. Hereinafter, the command reception queue and the response reply queue are also referred to as “real queues”.

Each CPU included in the second controller 230 has a virtual command reception queue and a virtual response reply queue. The virtual command reception queue and the virtual response reply queue are realized by an area secured in the DRAM 220 of the smart NIC 200. The virtual command reception queue and the virtual response reply queue are, for example, ring buffers. Hereinafter, the virtual command reception queue and the virtual response reply queue are also referred to as “virtual queues”. That is, although there is only one real queue, there are as many virtual queues as the number of cores, and thus, it is necessary to merge the queues or divide the queue. The real queue and the virtual queue are separated to absorb the difference in the current configuration in which the number of queues in the storage controller 100 is different from the number of cores in the CPU core 132 of the smart NIC 200.

Each core in the CPU core 132 performs reception processing, transmission processing, and queue handling. The reception processing is processing up to storage in the queue, specifically, the virtual command reception queue in the processing described with reference to FIG. 7 when communication from the host 99 to the storage controller 100 is relayed. The transmission processing is processing subsequent to processing of acquiring a storage interface command from the virtual response reply queue when the communication from the host 99 to the storage controller 100 is relayed. The queue handling is to extract storage interface commands from virtual command reception queues of all the cores, merge the storage interface commands, and transmit the merged storage interface command to the real queue of the storage controller 100 by DMA transfer, and divide a storage interface command acquired from the real queue of the storage controller 100 and store the divided storage interface commands in the respective virtual response reply queues by DMA transfer.

In the smart NIC 200, the same connection is handled by the same core. The purpose of this is to conserve resources, avoid cumbersome management, and to avoid performance degradation caused by conflicts and mutual exclusion waits between cores. For example, when the core R3 receives a data request from a certain host 99, the core R3 transmits data acquired from the storage controller 100 as a response thereto.

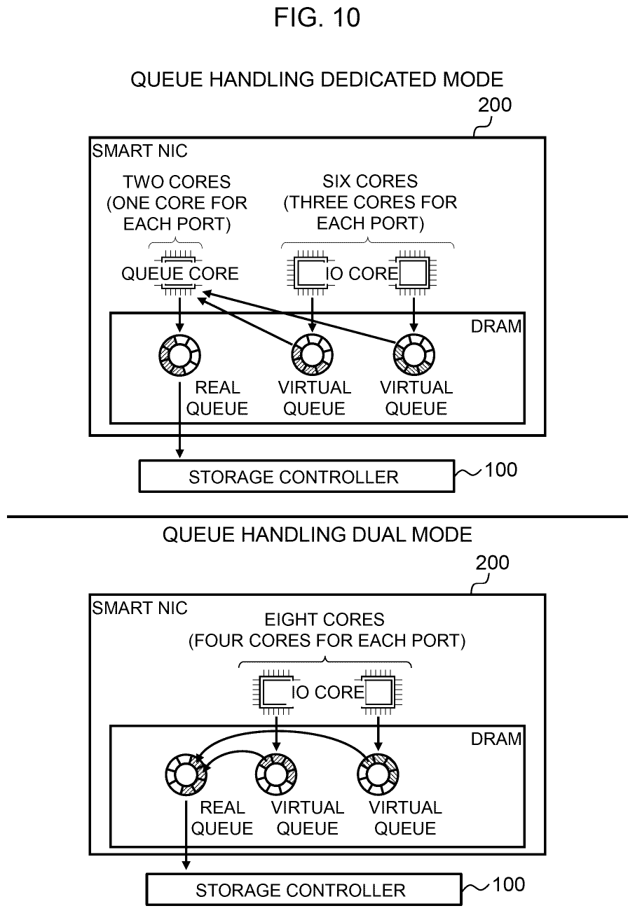

FIG. 10 is a diagram for explaining the queue handling dedicated mode and the queue handling dual mode. However, here, as illustrated in the lower part of FIG. 5, it is assumed that the CPU resource is allocated to each port by 50%. The upper part of FIG. 10 illustrates the queue handling dedicated mode, and the lower part of FIG. 10 illustrates the queue handling dual mode. The difference between the queue handling dedicated mode and the queue handling dual mode is whether the cores are assigned roles.

In the queue handling dedicated mode illustrated in the upper part of FIG. 10, a dedicated core for performing queue handling is set for each port. In the present embodiment, since each smart NIC 200 has two ports, port 0 and port 1, two cores are engaged only in queue handling. Therefore, in this case, the remaining six cores have virtual queues and perform reception processing and transmission processing. Focusing on one port, one core performs only queue handling, and three cores perform reception processing and transmission processing.

In the queue handling dual mode illustrated in the lower part of FIG. 10, all the cores perform queue handling, reception processing, and transmission processing. In this case, which core performs the queue handling is undefined. For example, the same core may perform all of queue handling, reception processing, and transmission processing for a command from a certain host 99. In this case, four cores perform queue handling, reception processing, and transmission processing for each port.

Hereinafter, an arithmetic core that performs the reception processing and the transmission processing is referred to as an “IO core”, and an arithmetic core that performs the queue handling is referred to as a “queue core”. In the queue handling dedicated mode, the IO core and the queue core are fixed, but in the queue handling dual mode, the IO core and the queue core are fluid. That is, in the queue handling dual mode, one core operates as an IO core at a certain timing, but operates as a queue core at another timing. The same number of virtual queues as the IO cores are prepared, and in the queue handling dedicated mode, the virtual queues in the lower diagram obtained by subtracting the number of queue cores from the number of arithmetic cores included in the CPU core 132 are prepared. In the queue handling dual mode, the number of IO cores varies depending on the timing, but since any core can be an IO core, virtual queues as many as the arithmetic cores included in the CPU core 132 are prepared.

There is no clear superiority or inferiority between the queue handling dedicated mode and the queue handling dual mode, each having an advantage and a disadvantage. The advantage of the queue handling dedicated mode is that since the core that performs the queue handling is fixed, an exclusion process between the cores for handling the queues is unnecessary, and there is no overhead of the exclusion process. On the other hand, there is a disadvantage that the number of cores that perform IO processing is reduced. The advantage of the queue handling dual mode is that the number of cores for performing IO processing can be increased. The disadvantage of the queue handling dual mode is that an exclusion process between the cores for handling the queue is required.

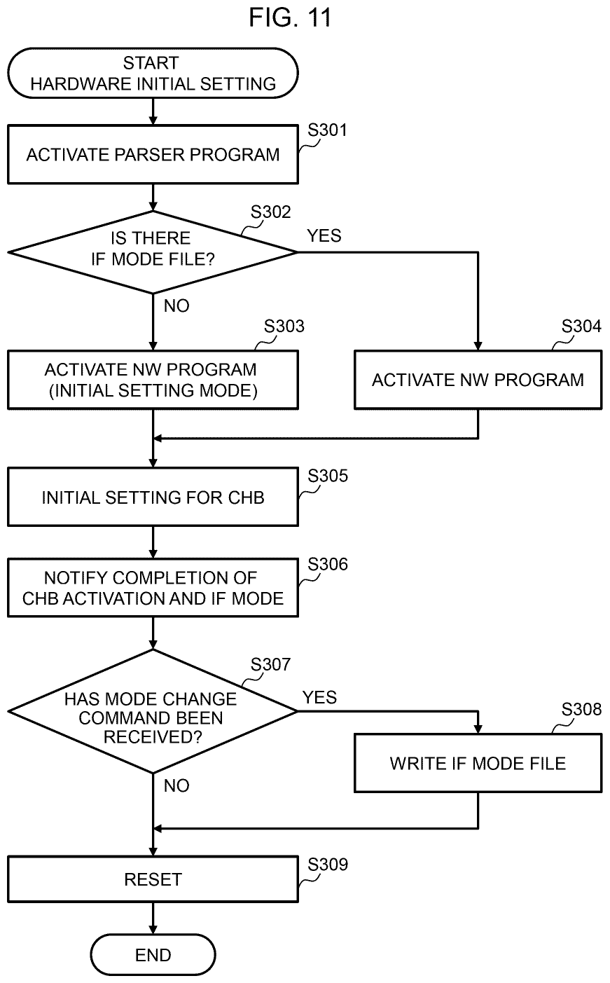

FIG. 11 is a flowchart illustrating processing at the time of hardware initial setting of the smart NIC 200. The smart NIC 200 executes hardware initial setting according to an instruction from the storage controller 100. For example, when the operator of the smart NIC 200 newly connects the smart NIC 200 to the storage controller 100, the storage controller 100 instructs the newly connected smart NIC 200 to execute hardware initial setting.

The smart NIC 200 first activates a parser program in step S301. In the subsequent step S302, the parser program 222 determines whether an IF mode file 243 exists. When an IF mode file 243 does not exist, the processing proceeds to step S303, and when an IF mode file 243 exists, the processing proceeds to step S304. In step S303, referring to the smart NIC operation protocol mode table 221, the parser program activates a network program for the initial setting mode, that is, “iSCSI Target” corresponding to “no file exists” in the example of FIG. 5, and proceeds to step S305.

In step S304, referring to the smart NIC operation protocol mode table 221 based on the description of the IF mode file 243, the parser program specifies a network protocol for each port, activates a corresponding network program, and proceeds to step S305. In step S305, the smart NIC 200 performs initial setting for the channel board. In the subsequent step S306, the smart NIC 200 notifies the storage controller 100 of completion of activation of the channel board and the IF mode for each port. For example, when a negative determination is made in step S302, a notification such as “CHB activation completed, Port 0: iSCSI, Port 1: iSCSI” is transmitted from the smart NIC 200 to the storage controller 100.

The storage controller 100 having received this notification transmits a mode change command to the smart NIC 200 when the IF mode does not match the protocol setting table 122. For example, the storage controller 100 having received the aforementioned notification from the smart NIC 200 of which the channel board ID “C1” transmits “Mode change command, Port 0: iSCSI, Port 1: NVMe” or the like to the smart NIC 200 because port 1 does not match the protocol setting table 122 illustrated in FIG. 2. Hereinafter, the IF mode included in the mode change command to be set is also referred to as a “designated mode”.

In the subsequent step S307, the smart NIC 200 determines whether a mode change command has been received from the storage controller 100. When the smart NIC 200 determines that a mode change command has been received, the processing proceeds to step S308, and when the smart NIC 200 determines that a mode change command has not been received, the processing proceeds to step S309. In step S308, the file writing program 224 of the smart NIC 200 writes the designated mode for each port described in the mode change command into the IF mode file 243, and the processing proceeds to step S309. In step S309, the smart NIC 200 resets the smart NIC 200, and ends the processing illustrated in FIG. 11.

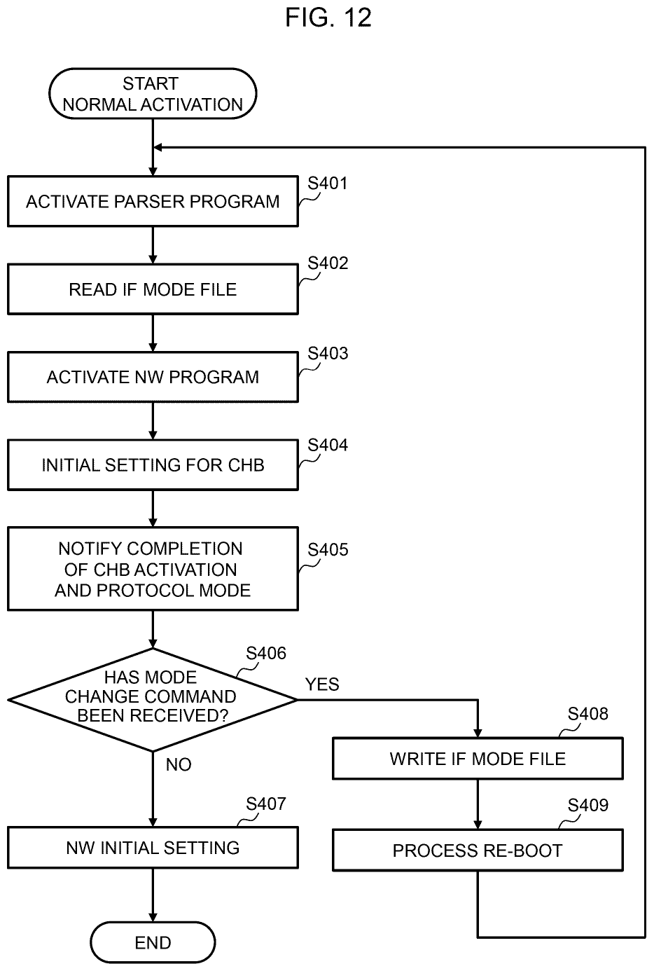

FIG. 12 is a flowchart illustrating processing at the time of normal activation of the smart NIC 200. The processing illustrated in FIG. 12 is executed when power supply to the smart NIC 200 is simply started while the smart NIC 200 does not receive a special instruction from the storage controller 100, or after the reset in step S309 of FIG. 11. In FIG. 12, the same processing as that in FIG. 11 is denoted by the same term. First, in step S401, similarly to step S301, the smart NIC 200 activates a parser program 222. In the subsequent step S402, the IF mode file 243 written in step S308 of FIG. 11 is read. In subsequent step S403, the smart NIC 200 activates a protocol processing program 228 based on the description of the IF mode file 243. For example, in a case where the IF mode file 243 is that illustrated in the lower part of FIG. 4, the iST program 2281 and the NVMe program 2282 are activated as the protocol processing program 228.

In the subsequent step S404, similarly to step S305 of FIG. 11, the smart NIC 200 performs initial setting for the channel board. In the subsequent step S405, similarly to step S306 of FIG. 11, the smart NIC 200 notifies the smart NIC 200 of the completion of activation of the channel board and the IF mode. In the subsequent step S406, the smart NIC 200 determines whether a mode change command has been received from the storage controller 100. When the smart NIC 200 determines that a mode change command has been received, the processing proceeds to step S408, and when the smart NIC 200 determines that a mode change command has not been received, the processing proceeds to step S407.

Note that the processing itself in step S406 is the same as that in step S307 of FIG. 11, but has a different meaning. In step S307 of FIG. 11, it is assumed that an IF mode file 243 does not exist because the processing is performed at the time of hardware initial setting, and thus, a change command is received from the storage controller 100 unless initial setting values accidentally match the protocol setting table 122. That is, in most cases, a change command is received and a positive determination is made in step S307 of FIG. 11. On the other hand, in FIG. 12, since an IF mode designated by the storage controller 100 is written in step S308 of FIG. 11 executed immediately before, no further change command should be received, and a positive determination is made in step S406 only in a special case such as a write error.

In step S407 executed when a negative determination is made in step S406, the smart NIC 200 performs network initial setting and ends the processing illustrated in FIG. 12. In FIG. 11, the reset (S309) is executed regardless of the determination in step S307, but in a case where a negative determination is made in FIG. 12, processing similar to the reset is not executed.

In step S408 executed when a positive determination is made in step S406, similarly to step S308 of FIG. 11, the file writing program 224 of the smart NIC 200 writes the designated mode for each port described in the mode change command into the IF mode file 243, and the processing proceeds to step S409. In step S409, the smart NIC 200 performs a process re-boot and returns to step S401. Since a positive determination is made in step S406 in an exceptional situation as described above, when this process determination is made a predetermined number of times in succession, a blocking process may be performed to disable the smart NIC 200.

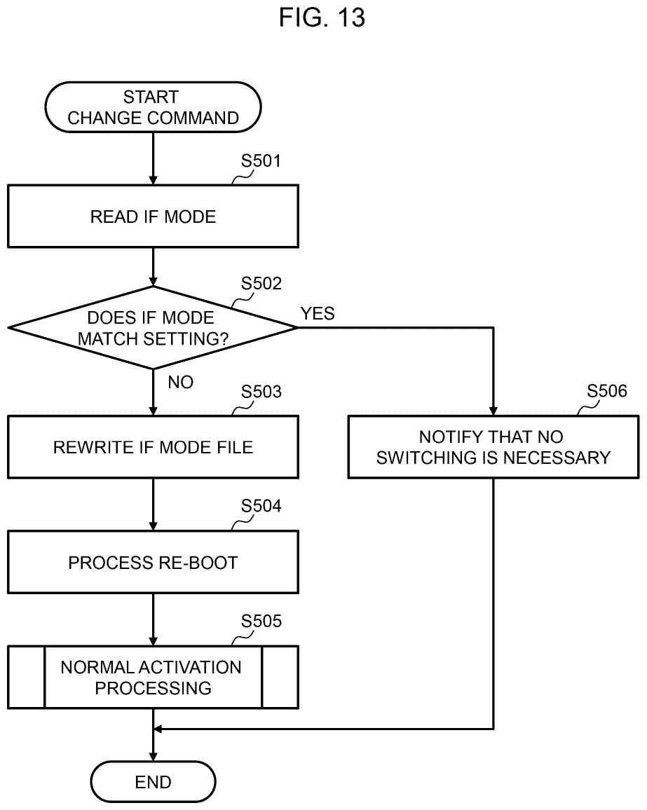

FIG. 13 is a flowchart illustrating processing of the smart NIC 200 when the IF mode of the smart NIC 200 is switched by the user, in other words, mode change processing. In step S501, the smart NIC 200 reads the new setting designated by the user and received via the storage controller 100 and the IF mode described in the IF mode file 243. In the subsequent step S502, the smart NIC 200 determines whether or not the new setting and the IF mode read in step S501 match. When the smart NIC 200 determines that the new setting and the IF mode match, the processing proceeds to step S506, and when the smart NIC 200 determines that the new setting and the IF mode do not match, the processing proceeds to step S503.

In step S503, the smart NIC 200 rewrites the IF mode file 243 based on the designation of the user. In the subsequent step S504, the smart NIC 200 executes a process re-boot. In step S505, the smart NIC 200 executes the normal activation processing illustrated in FIG. 12 and ends the processing illustrated in FIG. 13.

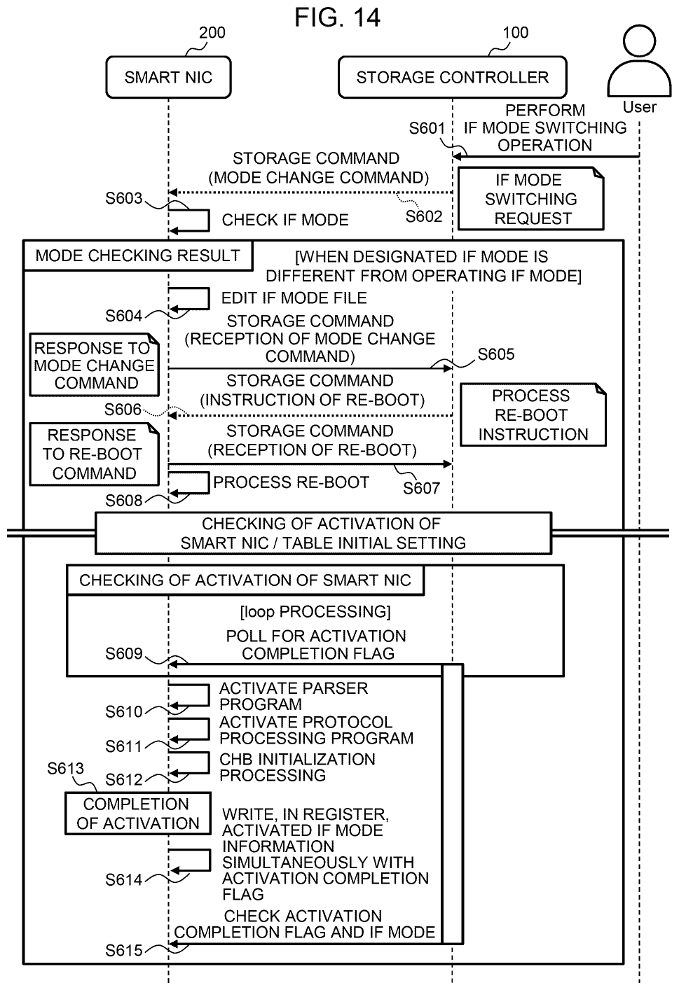

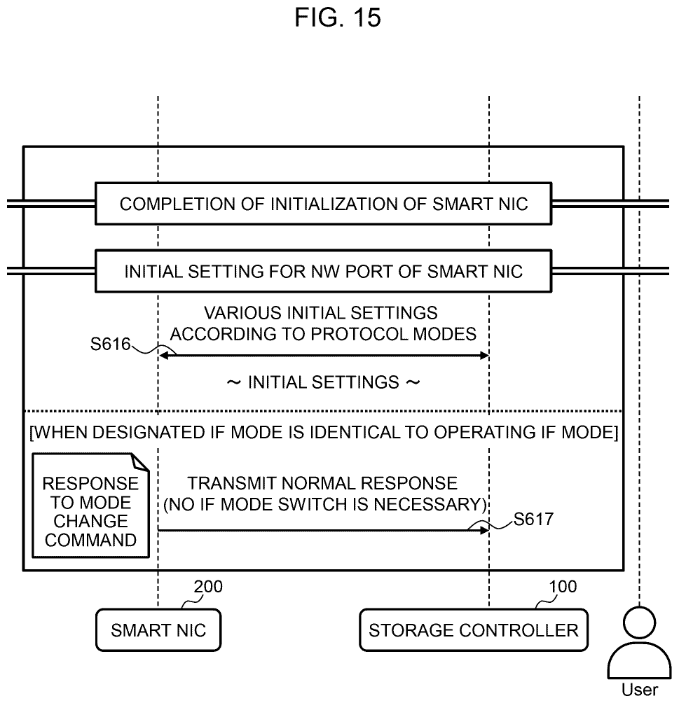

FIGS. 14 and 15 are time charts illustrating processing of the storage system 1 in a case where the IF mode of the smart NIC 200 is switched by the user. This series of steps is too long to be included in one diagram, and thus is divided into two diagrams. That is, in each of FIGS. 14 and 15, the time elapses from the upper part to the lower part in the diagram, and the beginning of FIG. 15 is a later time than the end of FIG. 14.

First, the user performs an operation on the storage controller 100 for switching the IF mode of the smart NIC 200 (S601). The IF mode switching operation may be realized using an input device (not illustrated) included in the storage controller 100, or may be performed by uploading a file storing a new IF mode from a terminal used by the user to the storage controller 100. When the user performs the IF mode switching operation, the storage controller 100 transmits a storage command including data specifying a new IF mode, that is, a mode change command, to the smart NIC 200 (S602).

The smart NIC 200 that has received the mode change command checks a current IF mode (S603), and when the designated IF mode is different from the current IF mode, S604 to S615 to be described below are performed. Processing when the designated IF mode and the current IF mode match will be described below. In S604, the smart NIC 200 edits the IF mode file 243 and writes the designated IF mode. Then, the smart NIC 200 transmits a response indicating that the mode change command has been received to the storage controller 100 (S605). The storage controller 100 that has received this response transmits a storage command including instruction of process re-boot to the smart NIC 200 (S606). The smart NIC 200 that has received the storage command transmits a storage command including reception of re-boot to the storage controller 100 and executes the process re-boot (S608).

Thereafter, the storage controller 100 continues polling for checking the activation of the smart NIC 200 (S609). When activated, the smart NIC 200 activates the parser program 222 (S610), and the parser program 222 activates the protocol processing program 228 based on the description of the IF mode file 243 (S611). When the channel board initialization processing is completed (S612), the activation of the smart NIC 200 is completed (S613). The smart NIC 200 writes the IF mode at the time of activation to the register simultaneously with an activation completion flag (S614). Then, the storage controller 100 checks the activation completion flag and the IF mode of the smart NIC 200 (S615). The description will be continued with reference to FIG. 15.

The initialization of the smart NIC 200 is completed by the above-described processing, and the initial setting for the network port of the smart NIC 200 is performed. Specifically, various initial settings according to the protocol modes are executed between the storage controller 100 and the smart NIC 200 (S616). After S602 described above, when the designated IF mode matches the current IF mode, the smart NIC 200 transmits a normal response indicating that it is not necessary to switch the IF mode to the storage controller 100 (S617). This processing corresponds to step S506 in FIG. 13.

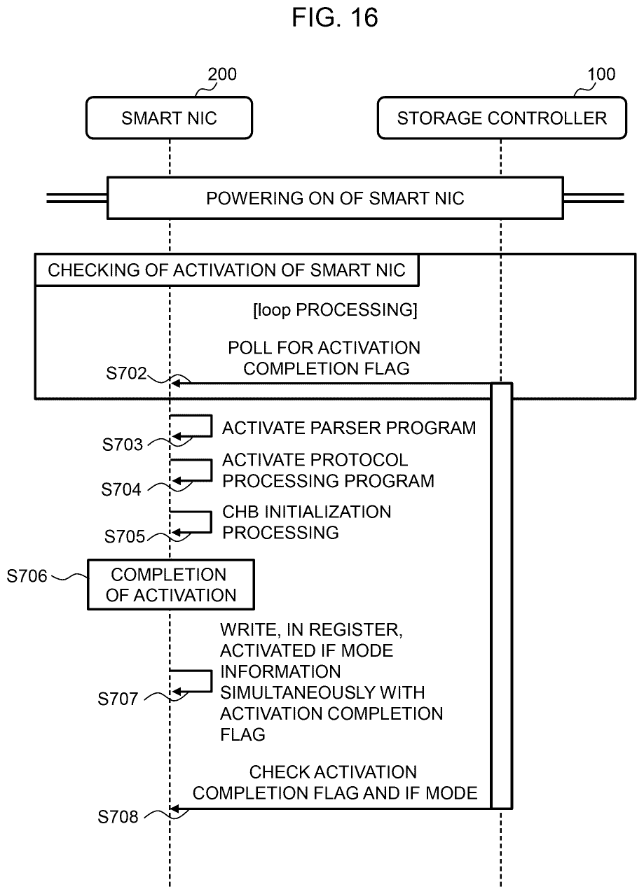

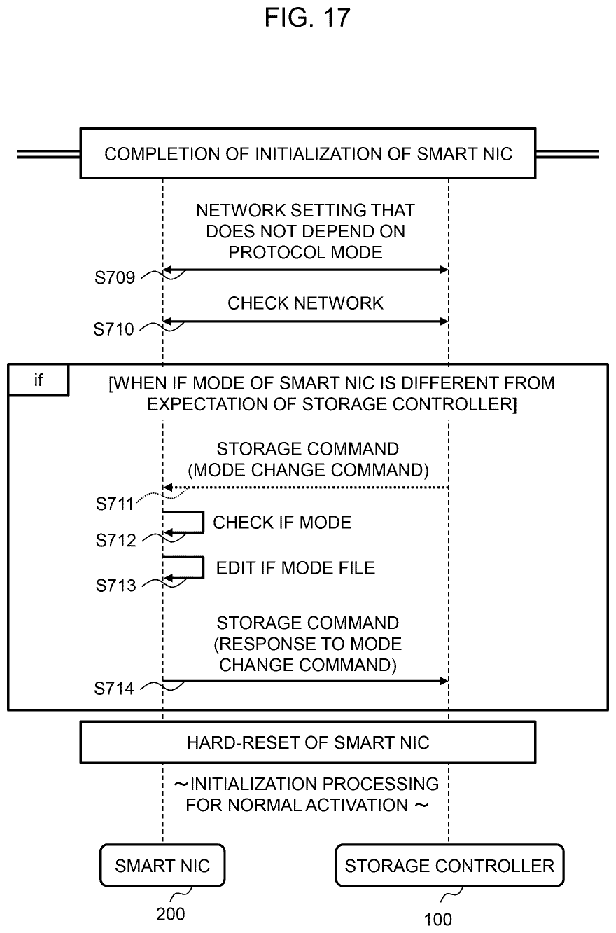

FIGS. 16 and 17 are time charts illustrating processing at the time of hardware initial setting of the smart NIC 200. This series of steps is too long to be included in one diagram, and thus is divided into two diagrams. That is, in each of FIGS. 16 and 17, the time elapses from the upper part to the lower part in the diagram, and the beginning of FIG. 17 is a later time than the end of FIG. 16.

First, the smart NIC 200 is powered on together with a hardware initial setting command. The storage controller 100 continues polling for checking the activation of the smart NIC 200 (S702). When activated, the smart NIC 200 activates the parser program 222 (S703), and the parser program 222 activates the protocol processing program 228 based on the description of the IF mode file 243 (S704). The activation of the parser program corresponds to step S301 in FIG. 11, and the activation of the protocol processing program 228 corresponds to steps S302 to S304 in FIG. 11.

When the channel board initialization processing is completed (S705), the activation of the smart NIC 200 is completed (S706). The smart NIC 200 writes the IF mode at the time of activation to the register simultaneously with an activation completion flag (S707, S306 in FIG. 11). Then, the storage controller 100 checks the activation completion flag and the IF mode of the smart NIC 200 (S708). The description will be continued with reference to FIG. 17.

The initialization of the smart NIC 200 has been completed so far. Next, the storage controller 100 and the smart NIC 200 perform network setting that does not depend on the protocol mode (S709). Since the IF mode of the smart NIC 200 may be different from the expectation of the storage controller 100, the setting that does not depend on the network protocol is performed here. Note that this network setting corresponds to the network port initial setting of the smart NIC 200 illustrated in FIG. 15. Next, the storage controller 100 performs a network check (S710), for example, an internal loop-back test. In order to execute this network check, it is necessary to execute network setting (S709) that does not depend on a network protocol as a preliminary step.

When the IF mode of the smart NIC 200 is different from the expected mode, that is, different from the description in the protocol setting table 122, the storage controller 100 transmits a storage command including data specifying a new IF mode, that is, a mode change command to the smart NIC 200 (S711). The smart NIC 200 that has received the mode change command checks the current IF mode (S712), and edits the IF mode file 243 to write the designated IF mode (S713). Then, the smart NIC 200 transmits a response to the mode change command to the storage controller 100 (S714). Thereafter, hard-reset of the smart NIC 200 is executed, and initialization processing is performed at the time of normal activation.

According to the first embodiment described above, the following advantageous effects can be obtained.
(1) The smart NIC 200, which is an interface module, includes an embedded memory 240 that stores a first firmware 240A, a second firmware 240B, and an IF mode file 243, and a CPU core 231 that executes program codes included in the first firmware 240A and the second firmware 240B. Each version of the firmware includes a plurality of protocol-based program codes such as an iST program code 2281-0, and a parser program code 222-0 that realizes a parser program 222 that activates at least one of the plurality of protocol-based program codes based on the description of the IF mode file 243. Since it is not necessary to switch a protocol by firmware exchange while supporting a plurality of network protocols, it is possible to minimize downtime. If the protocol-based program code is stored in a different version of firmware for each protocol, the size of each version of firmware is reduced, but firmware exchange is essential for switching the protocol, increasing downtime. In addition, since it is not necessary to prepare separate firmware for each protocol, not only hardware but also software can be unified.
(2) The smart NIC 200 includes a file writing program 224 that, when a designated mode indicating a protocol of a program code to be executed at the time of activation is designated, rewrites the IF mode file 243 to activate a protocol-based program code that is the indicated protocol in a case where the IF mode file 243 indicates that a protocol-based program code different from the designated mode is activated (S502: NO, S503 in FIG. 13).
(3) When the IF mode file 243 is rewritten, the parser program 222 terminates the activated protocol-based program code and activates a protocol-based program code based on the description of the rewritten IF mode file 243 (S504 in FIG. 13).
(4) The smart NIC 200 includes a plurality of communication ports. The parser program 222 determines the number of processors allocated to each of the communication ports based on the CPU setting table 223 created in advance. Therefore, the operation resources can be allocated according to an expected communication amount for each of the communication ports.
(5) The smart NIC 200 includes a file writing program 224 that writes the IF mode file 243 into the embedded memory 240 at the time of hardware initial setting.
(6) When the IF mode file 243 does not exist (S302: NO in FIG. 11), the parser program 222 starts a protocol-based program code determined in advance.
(7) The storage controller 100 includes a smart NIC 200-1, which can also be referred to as a first interface module, and a storage controller 100 that receives at least one of a read command and a write command via the first interface module.
(8) The storage controller 100 includes a controller DRAM 120 that stores a protocol setting table 122 indicating a designated mode which is a communication protocol to be used by the smart NIC 200, and a CHB setting program 125 that rewrites the mode file to activate a protocol-based program code of the designated mode when the IF mode file 243 of the smart NIC 200 indicates that a protocol-based program code of a protocol different from the designated mode is activated (S711 in FIG. 17).

### First Modification

In the first embodiment described above, among the programs stored in the DRAM 220, only the protocol processing program 228 is prepared for each network protocol. However, the command processing program 226, the command conversion program 227, and the queue handling program 229 may also be prepared for each network protocol.

### Second Modification

In the first embodiment described above, the storage controller 100 determines whether the modes match at the time of hardware initialization and at the time of normal activation, and notifies the smart NIC 200 of the result as an IF mode switching command. However, the storage controller 100 may notify the smart NIC 200 of an expected IF mode, and the smart NIC 200 may determine whether the IF mode file 243 needs to be rewritten.

### Third Modification

In the first embodiment described above, the CPU setting table 121 is stored in the controller DRAM 120, and the queue handling mode and the allocation of CPU resources can be set. However, the queue handling mode may be fixed to either the queue handling dedicated mode or the queue handling dual mode, or the allocation of CPU resources may be unchangeable and fixed to, for example, 50%.

### Fourth Modification

In the first embodiment described above, the same connection is handled by the same core. However, the same connection may be handled by different cores. In addition, it is not essential that the second controller 230 has a plurality of CPU cores 231, and the second controller 230 may have only one CPU core 231.

### Fifth Modification

In the first embodiment described above, two versions of firmware are stored in the embedded memory 240. However, the configuration in which two versions of firmware are stored is merely illustrated with a typical firmware update procedure in mind, and only one version of firmware may be stored in the embedded memory 240. In addition, three or more versions of firmware may be stored in the embedded memory 240.

### Sixth Modification

In the first embodiment described above, the smart NIC 200 includes port 1 and the port 2, that is, a plurality of communication ports. However, the smart NIC 200 may include only one communication port.

### SECOND EMBODIMENT

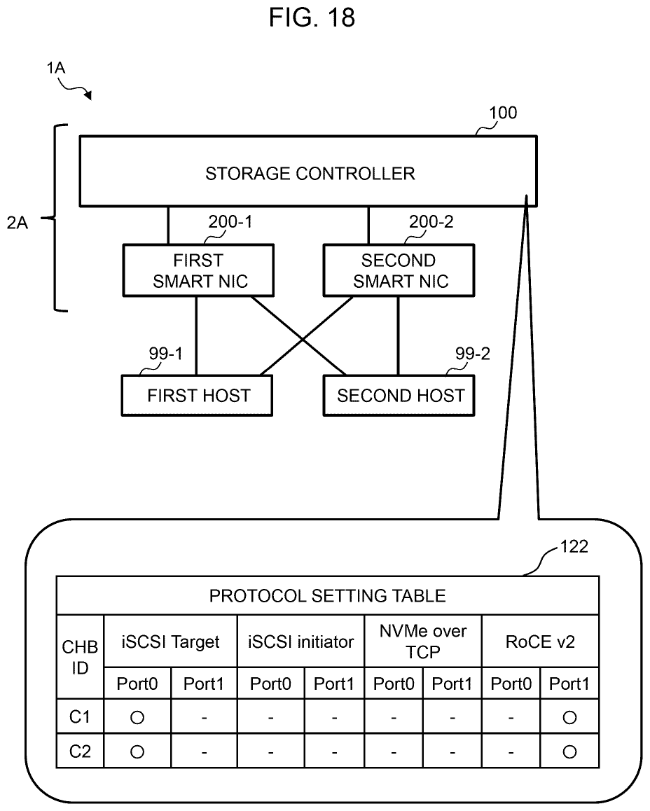

A smart NIC according to a second embodiment will be described with reference to FIG. 18. In the following description, the same components as those in the first embodiment are denoted by the same reference numerals, and differences will be mainly described. The points that are not specifically described are the same as those in the first embodiment. The present embodiment is different from the first embodiment mainly in that a redundant configuration is realized.

FIG. 18 is an overall configuration diagram of a storage system 1A according to the second embodiment. A first smart NIC 200-1 and a second smart NIC 200-2 are connected to the storage controller 100. Hereinafter, the storage controller 100, the first smart NIC 200-1, and the second smart NIC 200-2 are collectively referred to as an information communication device 2A. A first host 99-1 is connected to the first smart NIC 200-1 and the second smart NIC 200-2. A second host 99-2 is connected to the first smart NIC 200-1 and the second smart NIC 200-2.

The first host 99-1 and the second host 99-2 use different communication protocols. For example, the first host 99-1 uses iSCSI, and the second host 99-2 uses ROCE V2. Each of the first smart NIC 200-1 and the second smart NIC 200-2 includes two ports, and communication protocols corresponding to the first host 99-1 and the second host 99-2, respectively, are set. That is, a protocol setting table 122 illustrated in the lower part of FIG. 18 is stored in the storage controller 100 in the present embodiment.

The information communication device 2A realizes communication redundancy by using two smart NICs 200. That is, even if a failure occurs in any one of the first smart NIC 200-1 and the second smart NIC 200-2, communication between the first host 99-1 and the second host 99-2 and the storage controller 100 can be continued.

According to the second embodiment described above, the following advantageous effects can be obtained.
(9) The information communication device 2A includes a first smart NIC 200-1 and a second smart NIC 200-2, each of which is the interface module according to claim 1, and a storage controller 100. Each of the first smart NIC 200-1 and the second smart NIC 200-2 includes two communication ports, and is capable of supporting different communication protocols for the respective communication ports. In the present embodiment, each of the first smart NIC 200-1 and the second smart NIC 200-2 includes two communication ports and thus supports two or more communication protocols. According to the description of the protocol setting table 122, a combination of communication protocols supported by the first smart NIC 200-1 matches a combination of communication protocols supported by the second smart NIC 200-2. Therefore, redundancy of communication can be realized using the two smart NICs 200.

The configuration of the functional blocks in each of the above-described embodiments and modifications thereof is merely an example. Some functional components illustrated as separate functional blocks may be integrally configured, or a component illustrated in one functional block diagram may be divided into two or more functions. In addition, some of the function of each functional block may be included in another functional block.

The above-described embodiments and modifications thereof may be combined together. Although various embodiments and modifications have been described above, the present invention is not limited thereto. Other aspects conceivable within the scope of the technical idea of the present invention also fall within the scope of the present invention.

What is claimed is:

1. An interface module comprising:
a non-volatile storage area that stores one or more versions of firmware and a mode file; and
a processor that executes a program code included in the firmware,
wherein each version of the firmware includes:
a plurality of protocol-based program codes; and
an activation unit that activates at least one of the plurality of protocol-based program codes based on description of the mode file.

2. The interface module according to claim 1, further comprising:
a file rewriting unit that, when a designated mode indicating a protocol of a program code to be executed at the time of activation is designated, rewrites the mode file to activate the protocol-based program code that is the indicated protocol in a case where the mode file indicates that the protocol-based program code different from the designated mode is activated.

3. The interface module according to claim 2, wherein
when the mode file is rewritten, the activation unit terminates the protocol-based program code which is activated, and activates the protocol-based program code based on description of the mode file which is rewritten.

4. The interface module according to claim 1, further comprising
a plurality of communication ports,
wherein the processor includes a plurality of processors, and
the activation unit determines the number of processors allocated to each of the communication ports based on a CPU setting table created in advance.

5. The interface module according to claim 1, further comprising
a file writing unit that writes the mode file into the non-volatile storage area at the time of hardware initial setting.

6. The interface module according to claim 1, wherein
when the mode file does not exist, the activation unit activates the protocol-based program code determined in advance.

7. An information communication device comprising:
a first interface module including a first non-volatile storage area that stores one or more versions of first firmware and a first mode file; and
a first processor that executes a first program code included in the first firmware,
wherein each version of the first firmware includes:
a first plurality of protocol-based program codes; and
a first activation unit that activates at least one of the first plurality of protocol-based program codes based on a description of the first mode file; and
a storage controller that receives at least one of a read command and a write command via the first interface module.

8. The information communication device according to claim 7, further comprising:
a storage device that stores a protocol setting table indicating a designated mode that is a communication protocol to be used by the first interface module; and
a channel board setting unit that rewrites the first mode file to activate the first protocol- based program code of the designated mode when the first mode file of the first interface module indicates that the first protocol-based program code of a protocol different from the designated mode is activated.

9. The information communication device according to claim 7, further comprising
a second interface module including a second non-volatile storage area that stores one or more versions of second firmware and a second mode file; and
a second processor that executes a second program code included in the second firmware,
wherein each version of the second firmware includes:
a second plurality of protocol-based program codes; and
a second activation unit that activates at least one of the second plurality of protocol- based program codes based on a description of the second mode file,
wherein the storage controller receives at least one of a read command and a write command via the first interface module and the second interface module,
each of the first interface module and the second interface module includes a plurality of communication ports, and is configured to support different communication protocols for each of the communication ports,
each of the first interface module and the second interface module supports two or more communication protocols, and
a combination of communication protocols supported by the first interface module and a combination of communication protocols supported by the second interface module match each other.

10. An activation method executed by an interface module including: a non-volatile storage area that stores one or more versions of firmware and a mode file; and a processor that executes a program code included in the firmware,
each version of the firmware including:
a plurality of protocol-based program codes; and
an activation unit that activates at least one of the plurality of protocol-based program codes based on description of the mode file,
the activation method comprising:
the processor operating the activation unit of any one version of the firmware to activate at least one of the plurality of protocol-based program codes based on the description of the mode file.
